(19) United States
(12) Patent Application Publication
(10) Pub. No.: US 2003/0120501 A1
(43) Pub. Date: Jun. 26, 2003

(54) Storage and updating of electronic documents in aircraft

(76) Inventors: David Alan Peters, Milford, OH (US); Michael Joseph Molezzi, Cincinnati, OH (US); Curt John Andersson, Canton, OH (US)

Correspondence Address: BARBARA JOAN HAUSHALTER, LAW OFFICE, 228 BENT PINES CT., BELLEFONTAINE, OH, 43311, US

(21) Appl. No.: 10/033,957

(22) Filed: Dec. 20, 2001

(51) Int. Cl. G06F 17/60

(52) U.S. Cl. 705/1

(57) ABSTRACT

A system for maintaining documents relating to aircraft. A first set of documents is carried onboard an aircraft, in computer-readable form. The set includes (1) the aircraft maintenance manual, (2) the aircraft maintenance log, (3) the aircraft configuration log, (4) task cards, (5) pilot logbooks, or any combination of these. Copies of some, or all, of the documents in the first set are maintained, in computer-readable format, at a ground-based location. As operation of the aircraft occurs, changes will occur in either, or both, sets of documents. The changes are then copied into the other set, to maintain consistency.

### FIELD OF THE INVENTION

The invention relates to storing and updating (1) aircraft maintenance records and (2) documents stored in electronic form, such as maintenance manuals.

### BACKGROUND OF THE INVENTION

At least five types of documents and data are associated with the operation of commercial aircraft.

One type is the maintenance manual, which explains operation, maintenance, and repair of the aircraft.

The second type is the maintenance logbooks, into which maintenance technicians record descriptions of the maintenance operations done, and repairs made, to the aircraft.

The third type includes task cards. Task cards are written requests, generally made by crew members, or based on information provided by crew members, which request testing, or repair, of individual aircraft components. For example, if a pilot finds that a radar altimeter malfunctions, the pilot will complete a task card requesting that the altimeter be tested, and repaired if necessary.

The fourth type is the pilots' logbooks. The pilots' logbooks report various activities undertaken by the pilots in operating the aircraft.

The fifth type is a configuration log, which lists the detailed components installed in the aircraft. The configuration log indicates, for example, the types of engines, radios, and so on, installed in the aircraft.

Some of these documents, such as the maintenance manuals and logs, can be quite large. Further, these documents change over time. Handling large paper documents, which change over time, can be cumbersome.

### SUMMARY OF THE INVENTION

The invention mitigates some of the problems in handling large documents needed for the operation of aircraft. In one form of the invention, copies of the documents are stored in electronic form in the aircraft, to enable local access and updates of all documents.

### BRIEF DESCRIPTION OF THE DRAWINGS

FIG. 1 illustrates an aircraft 3, flying over an airfield, which contains one form of the invention.

FIG. 2 illustrates in greater detail the collection 9 of documents in FIG. 1.

FIG. 3 illustrates how computers 30 and server 6 can communicate using a network 36.

FIG. 4 illustrates a second collection 56 of documents, stored in an earth-based computer 50, which represents sea-based computers as well, as in an aircraft carrier.

FIG. 5 illustrates changes 60, 63, and 66 which occurred in documents.

FIG. 6 illustrates schematically how the changes 60, 63, and 66 are replicated in corresponding documents.

FIG. 7 is a flow chart illustrating steps undertaken in one form of the invention.

### DETAILED DESCRIPTION OF THE INVENTION

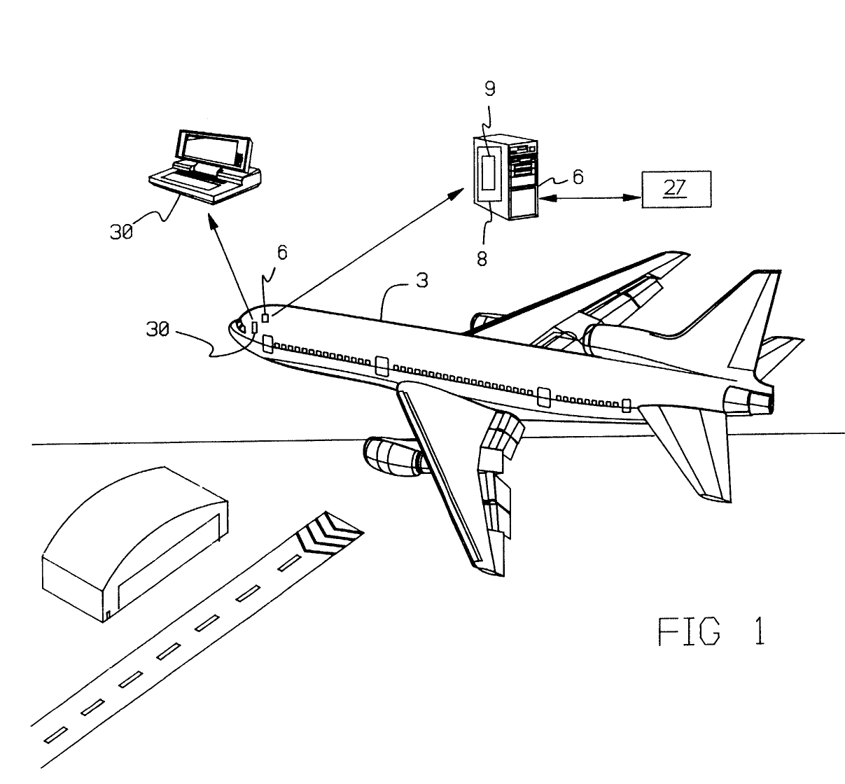

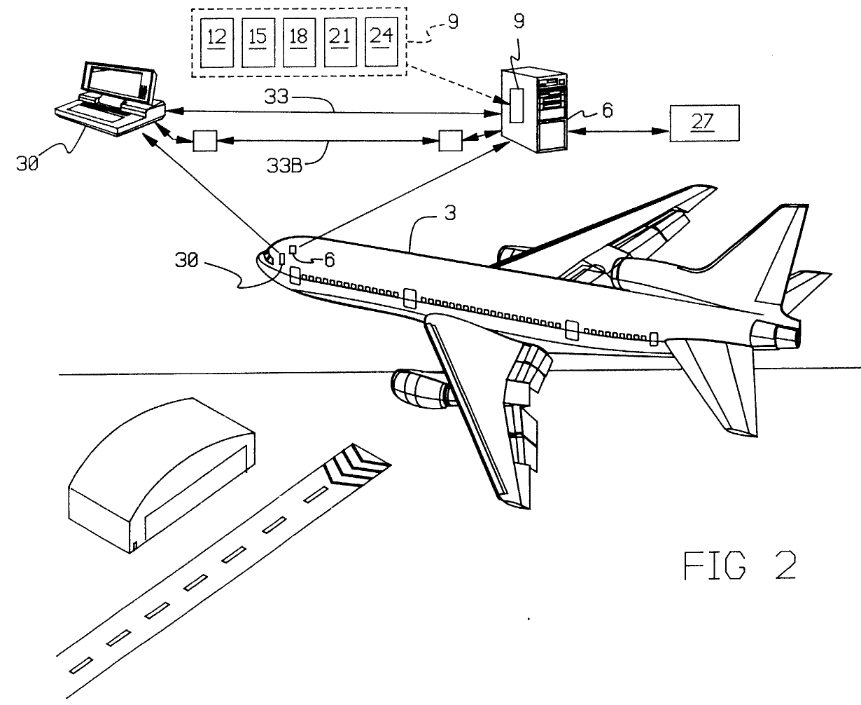

FIG. 1 illustrates an airborne aircraft 3, which contains a computer server 6, which is also indicated in enlarged form. The server 6 contains, in computer-readable memory 8, a collection of documents 9, shown as individual blocks in FIG. 2.

The documents 9 include (1) the maintenance manual 12 of the aircraft 3, (2) the task cards 15 of the aircraft 3, (3) the maintenance log 18 of the aircraft 3, (4) the configuration log 21 of the aircraft 3, and (5) the pilot logbooks 24.

As to the last item, each pilot of the aircraft 3 is assigned an individual logbook. Consequently, in general, multiple pilot logbooks will be stored in the server 6, and a single block 24 represents them.

These documents will change over time. For example, if a new radio is installed, an entry into the maintenance log 18 will be made to reflect the installation. In addition, the configuration log 21 will be modified to list the new radio, and removal of a previous radio, if removal occurred.

The modifications to the documents 18 and 21 are undertaken, for example, through an interface 27 to the server 6. The interface 27 may take the form of a standard keyboard, monitor, and pointing device (not individually shown). For example, when the installation of the radio discussed above occurs, the maintenance technician who installed the radio will call up the maintenance log 18 from the server 6, make the appropriate modification of the maintenance log 18, and replace the old maintenance log 18 with the modified maintenance log 18.

In one form of the invention, new entries to a maintenance log, or any other document, do not replace previous entries. Instead, a complete historical record of all entries in a document is maintained, so that new entries are treated as additions to the existing document, and no existing entries are either modified or deleted.

The maintenance log 18 and the other documents 9, in effect, are computer files, and are modified as such. Alternately, the documents 9 can take the forms of databases, which are computer files arranged in a specific structure. In addition, the documents 9 can take the form of other data structures.

Other modes of access to the server 6 can be provided. For example, one or more portable computers 30 in FIGS. 1 and 2 can be provided in the aircraft 3, for use by the crew and maintenance personnel in making the modifications. The portable computers 30 communicate with the server 6, for example, by a hard-wired connection, indicated by line 33 in FIG. 2, or by wireless connectivity indicated by line 336. Examples of wireless hardware include wireless devices manufactured by Proxima and Lucent Technologies.

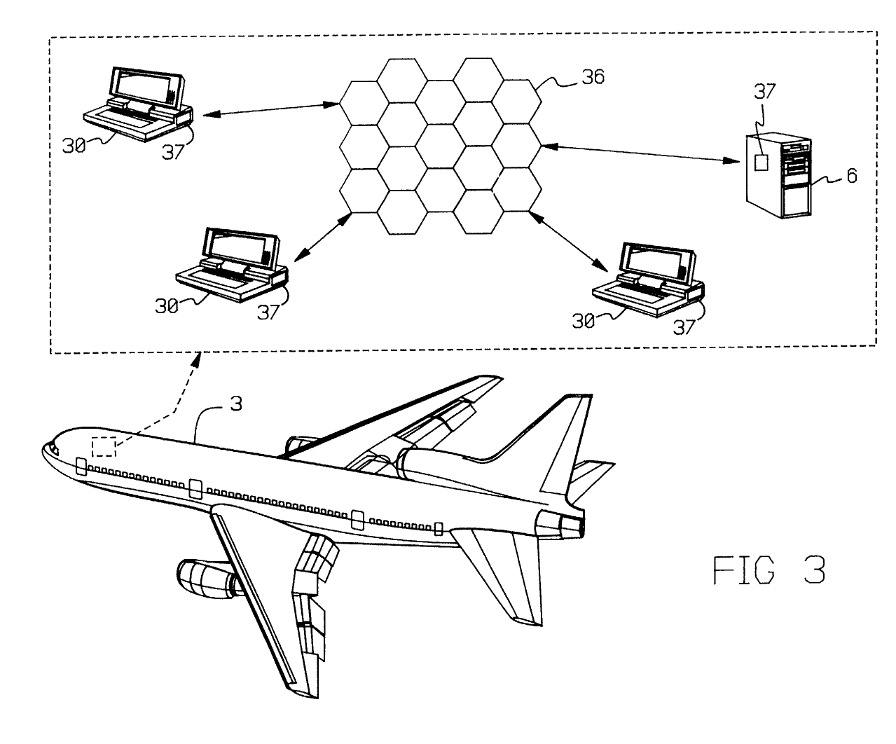

As another example, shown in FIG. 3, the portable computers 30 and the server 6 are connected by a network 36. Communications among the computers 30 and the server 6 are coordinated by network software, such as software conforming to the well known Ethernet standard, indicated by blocks 37.

One advantage of the network 36 is that it can be structured to resemble the widely used Internet, or World Wide Web. Many people are familiar with the Internet. Consequently, gaining familiarity with the network 36 in FIG. 3 amounts to a simple adaptation for such people.

Under the Internet analogy, each of the documents 9 in FIG. 2 takes the form of a web page. The invention imposes security as does the Internet, and grants access to web pages only to persons who present the proper passwords. Further, a higher level of security is imposed for modifications of web pages. Only persons presenting additional passwords are allowed to modify web pages.

The documents 9 in FIG. 2 can be stored in numerous different physical media. Further, as technology progresses, the media used can be expected to change. As one example, the documents can be stored on magnetic media, such as discs or tapes. As another example, the documents can be stored on optical CD ROMs, which have a capacity of about 650 Megabytes per disc. The CD ROMS can be re-writable or non-re-writable. As a third example, the documents can be stored on DVD ROMs. These examples are not exhaustive.

Therefore, under one form of the invention, five specific documents, which are involved in the operation of the aircraft, are stored in computer-readable format in the aircraft. The documents are accessed through a server 6 or portable computers 30, by parties demonstrating appropriate authority. The portable computers 30 are distributed throughout the aircraft 3, and may be connected by a network 36.

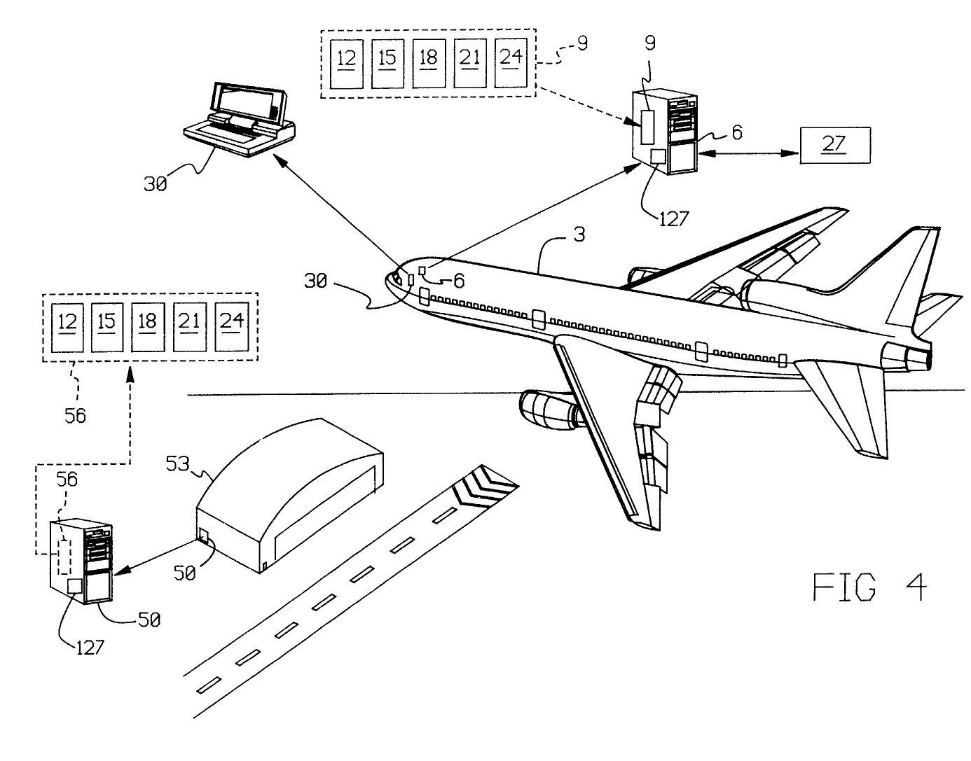

In another form of the invention, additional copies of the documents are stored at one, or more, other locations. For example, an earth-based computer 50 in FIG. 4, located in hangar 53, contains its own collection 56 of the documents 12, 15, 18, 21, and 24. The ground-based computer 50 which will generally be operated by the owner of the aircraft 3.

While hangar 53 is shown as being located on land, it can be earth-based in another sense, namely, in a naval aircraft carrier (not shown).

If the owner of the aircraft 3 operates multiple hangars, at different locations, then some, or all, of those hangars may be equipped with a computer 50, containing a copy 56 of the documents.

The collection of documents 9 need not contain all the documents contained in collection 56. The converse is also true: collection 56 need not contain all the documents in collection 9. As a specific example, collection 56 may contain the maintenance manual 12, the configuration log 21, and the maintenance log 18. Collection 56 need not contain the task cards 15, nor the pilots' logbooks 24.

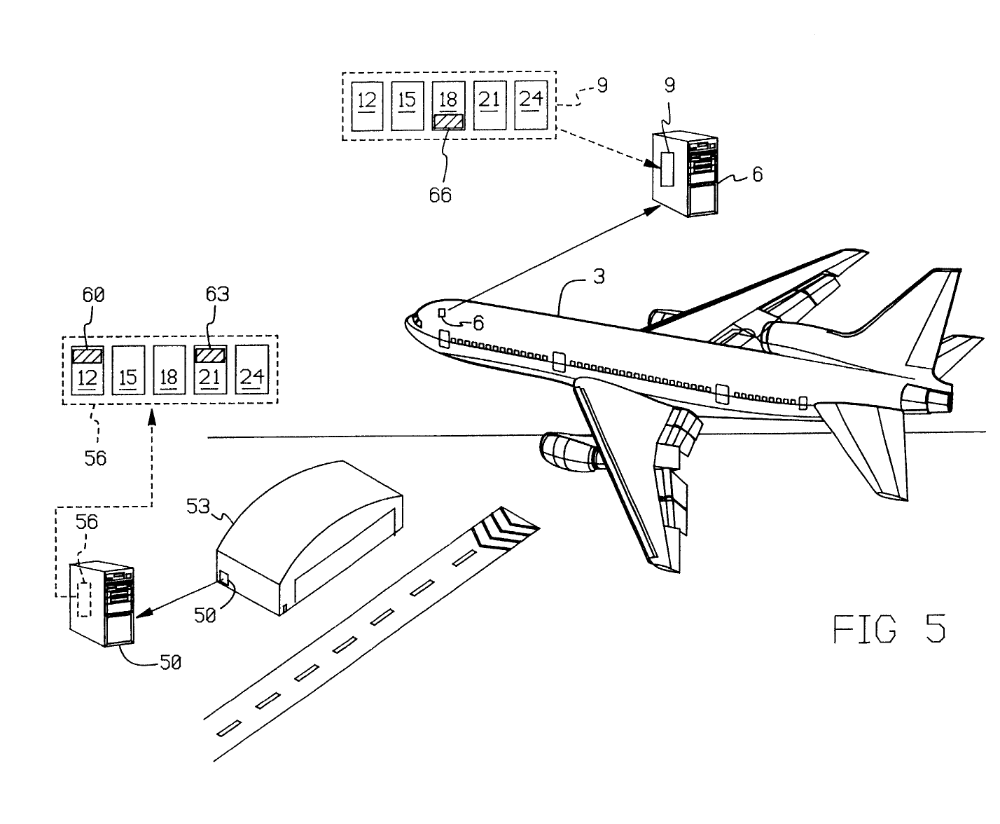

As explained above, the collections 9 and 56 will change as time progresses. For example, the pilots will change their logbooks 24, and the maintenance log 18 will change. In addition, the manufacturer of the aircraft 3 may change the maintenance manual 12, as when an improved maintenance procedure is developed. As shown in FIG. 5, blocks 60 and 63 indicate changes made to documents 12 and 21, respectively, in collection 56. Block 66 indicates a change made to document 18 in collection 9. Because of the changes, the two collections 9 and 56 are now inconsistent with each other.

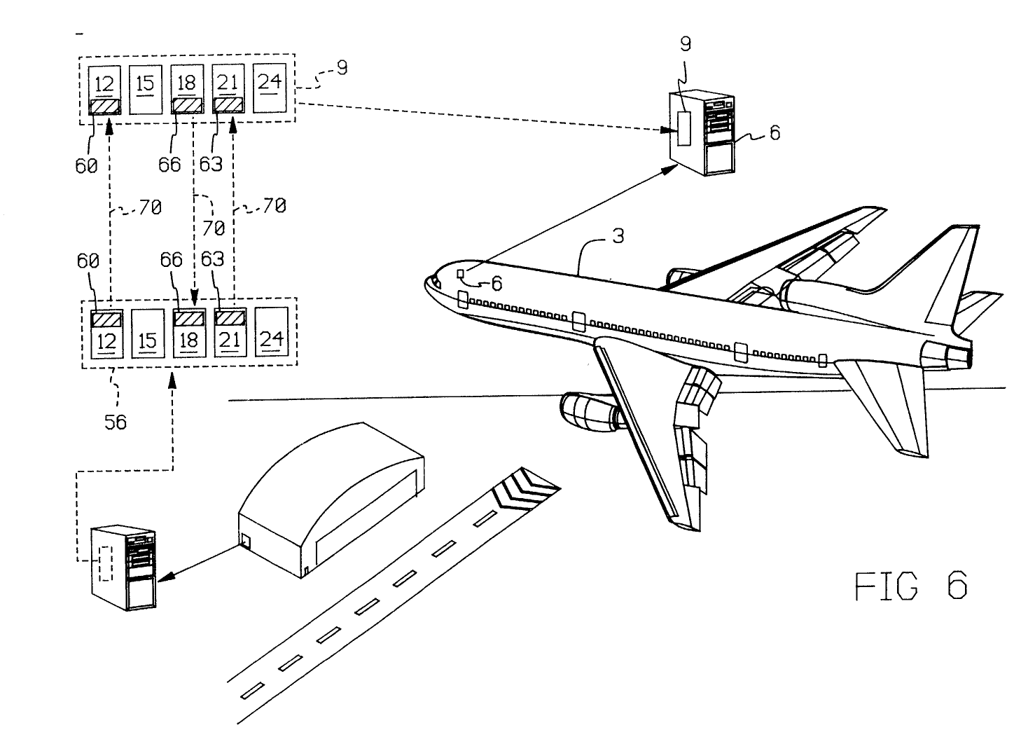

In order to remove the inconsistency, each change, such as change 60 in document 12 in collection 56, is also made in the corresponding document in the other collection 9. Arrows 70 in FIG. 6 indicate the propagation of the changes. If more than one other collection exists, the changes are made in all other collections containing the corresponding document.

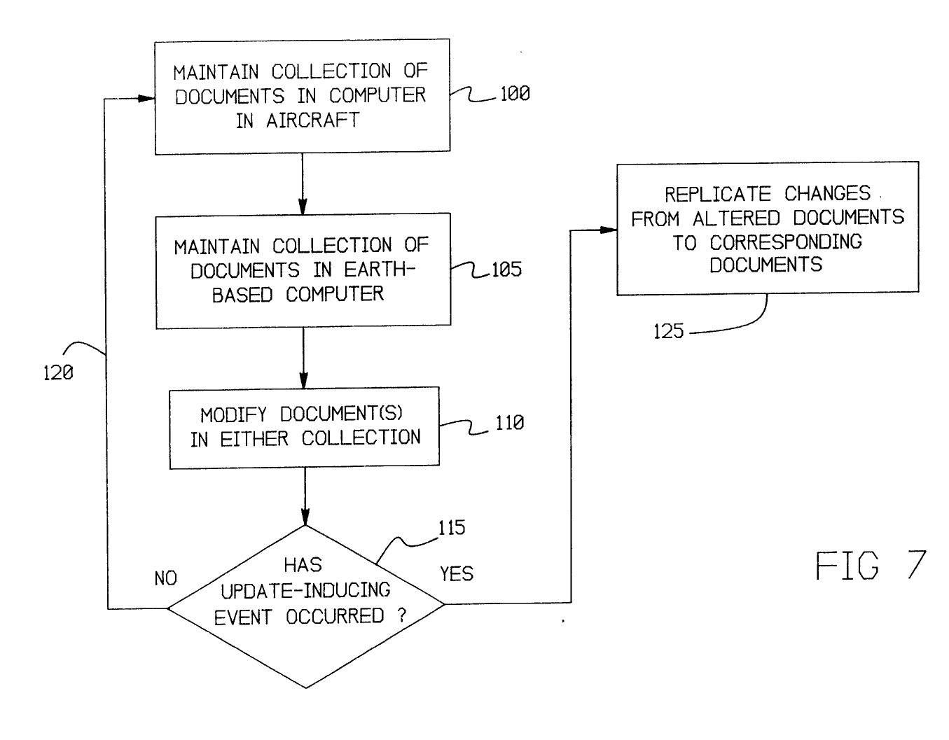

FIG. 7 is a flow chart of operational steps undertaken in one form of the invention. Block 100 indicates that a collection 9 in FIG. 4 of documents is maintained in computer-readable form in the aircraft 3. These documents preferably include all of the following five types, but can include a lesser subset if desired. The five types are (1) the maintenance manual 12, (2) the task cards 15, (3) the maintenance log 18, (4) the configuration log 21, and (5) the pilot logbooks 24.

Block 105 indicates that another collection 56 of the documents is maintained in computer-readable form in one, or more, ground-based computers 50. It is observed that the mere presence of both collections of the documents 9 and 56 provides benefits.

For example, if the aircraft should encounter a problem with a radar system, it is natural for an investigator to look to the maintenance logs 18 for information about the maintenance history. In addition, the investigator will also look to the maintenance manual 12, for assistance in diagnosis of the problem.

With copies of the maintenance log 18 and the maintenance manual 12 located within both the aircraft 3 and the earth-based computer 50 in FIG. 4, multiple parties can participate in solving the problem.

Block 110 indicates that documents within either, or both, collections are modified. Decision block 115 looks for the occurrence of an update-inducing event. Until the update-inducing event occurs, arrow 120 indicates that the steps of blocks 100, 105, and 110 are repeated.

When the update-inducing event occurs, block 125 indicates that all changes in any document are replicated in all corresponding documents in all other collections. Blocks 127 in FIG. 4 indicate known computer hardware and software which undertake communication which performs the replications. Blocks 127 also represent software and hardware which detect the update-inducing events, and perform the replications of block 125.

For example, the update-inducing event can be the arrival of 0100 GMT every Sunday. Blocks 127 can represent a program for (1) detecting the arrival of 0100 GMT on Sundays, (2) detecting the changes in the documents, and (3) transmitting the changes to other servers. Blocks 127 also represent cellular modems, communication software, and encryption/decryption software for securely transmitting the changes.

Regarding the meaning of the term corresponding, two maintenance manuals 12 are corresponding documents; however, a maintenance manual 12 and a pilot logbook 24 are not corresponding documents.

The updating, or replication of changes into corresponding documents, can occur in numerous different ways. For example, the maintenance manual 12 may be stored on a CD ROM. The maintenance manual may be changed, as when a chapter is changed. As a specific example of how the change is made, the old chapter may be marked as obsolete on the CD ROM, and a new chapter written into fresh space on the CD ROM. The file allocation table of the CD ROM, which, in effect, is the table of contents, is then modified to indicate the new physical position of the new chapter. In this example, a new chapter replaces an old chapter, although the old chapter still exists physically on the CD ROM.

As another example, a new CD ROM is generated, which deletes the old chapter, and replaces the old chapter with the new chapter. The new CD ROM is distributed to all other collections of documents.

As a third example, only the changes are transmitted to the other collections. In this example, the changes would be (1) the fact of omission of the old chapter and (2) the contents of the new chapter. The computers handling the other collections modify their CD ROMS accordingly.

Other forms of disseminating the changes can be undertaken, apart from physically transporting media, as just described. For example, every collection, such as collection 9 in FIG. 2 and collection 565 in FIG. 4, are assigned electronic mail addresses. Electronic mail messages are transmitted which report the changes.

In this example, assume that three collections of documents exist, A, B, and C. The server handling each collection keeps track of its own changes. When an update-inducing event occurs, each server transmits an electronic mail message to the other servers, informing them of the changes.

Alternately, each collection can be assigned a URL, Uniform Resource Locator, according to the known Internet protocols. The changes can be distributed over the Internet, using the URLs as addresses.

Numerous approaches exist in the prior art for maintaining consistency in multiple copies of a given document. These approaches can be used by the invention, and are generically identified as versioning systems.

Multiple update-inducing events can be used in block 115 in FIG. 7. Further, different types of events can be used, at different times. For example, as stated above, one update-inducing event is the arrival of 0100 GMT every Sunday. Such an event is periodic.

As another example, another update-inducing event occurs when the total amount of data changed reaches a given size. For example, if a total of 1,000 alpha-numeric characters are required to report changes involved in collection 56 in FIG. 4 to collection 9, then that attainment is an update-inducing event.

As a third example, updates can be tied to the operation of the aircraft: whenever five landings occur, an update-inducing event arrives.

As a fourth example, these update-inducing events can be combined. The update-inducing event occurs every Sunday at 0100 GMT, or after five landings, whichever occurs first.

In addition, provision for an overriding update is made. For example, if (1) a government authority issues an important airworthiness directive, or equivalent, and (2) that directive is deemed highly relevant to the aircraft 3, then an overriding update is called. The directive is propagated to all collections of documents. In practice, it is expected that an earth-based computer 50 in FIG. 4 will perform the propagation.

One form of the invention applies to commercial aviation, to the exclusion of general aviation. One definition of commercial aviation relies on the fact that commercial aircraft carry passengers, or cargo, for hire. General aviation aircraft do not. Another form of the invention applies to all aircraft, including military aircraft.

In one form of the invention, one document of each type is considered a master document. Other documents of that type are copies of the master document. Changes made to the master document are propagated to the copies, but changes in the copies are never propagated to the master.

For example, the maintenance manual 12 in FIG. 4 will generally be published by the manufacturer of the aircraft. The manufacturer will also make modifications to the maintenance manual 12. In practice, the aircraft owner will keep a master version of the maintenance manual 12 at an earth-based location, such as server 50 in FIG. 4.

The master maintenance manual 12 will only be modified in response to changes made by the manufacturer of the aircraft 3. Those changes are then propagated to the copies, which will be located in the aircraft and the other hangars. But changes made to the copies will not be propagated to the master maintenance manual 12. One reason is that, in general, changes to the copies will not be authorized by the manufacturer.

An exception can sometimes occur. For example, a maintenance technician may locate a misprint in a copy of the master maintenance manual 12. The misprint indicates an error in the master maintenance manual 12. An engineer may generate a note, or annotation, which is propagated to the master maintenance manual. However, the content of the annotation is attributed to the engineer, not to the manufacturer of the aircraft. For example, the annotation may read, “In chapter 12, page 3, line 8, a 6 mm hex head cap screw is identified. That should be a 10 mm socket head cap screw.—Engineer Maxwell.” Thus, changes can sometimes be propagated from copies to the master manual, but the authorship of the copies is indicated.

Another form of the invention recognizes that a party utilizing a document is interested in the information contained within the document. The party is probably not interested in the location of the physical document itself. Therefore, in one form of the invention, a server 50 in FIG. 4 acts functionally as a web site, which stores the collection of documents 56. Server 6 within the aircraft 3 stores no documents 9, but contains communication equipment and software 127 which allows it to log into the web site, and locate documents of interest. For example, equipment 127 contains a cellular modem and a web browser.

Alternately, server 6 can be equipped with some documents, such as the maintenance log 18 and the pilots' logbooks 24. Other documents are stored within earth-based server 50. The latter documents are reached using the communication system 127, as by logging into the ground-based server 50 over the Internet, using cellular modems.

Therefore, in one form of the invention, documents 9 in FIG. 4 are stored within the aircraft 3, but in non-human-readable form. Two examples of non-human-readable form are (1) magnetic computer discs and (2) optical CD ROMs.

An apparatus capable of reading the documents 9, such as the server 6 and interface 27, does so, and displays human-readable versions of the documents 9, such as selected pages of the maintenance manual 12.

Numerous substitutions and modifications can be undertaken without departing from the true spirit and scope of the invention. What is desired to be secured by Letters Patent is the invention as defined in the following claims.

What is claimed is:

1. A system, comprising:
a) an aircraft;
b) a maintenance manual for the aircraft, stored in non-human-readable form aboard the aircraft; and
c) means for displaying the maintenance manual to a human.

2. A system, comprising:
a) an aircraft;
b) a first maintenance manual for the aircraft, stored in computer-readable form aboard the aircraft; and
c) means for displaying the maintenance manual to a human.

3. System according to claim 2, and further comprising:
d) a ground-based computer; and
e) a second maintenance manual for the aircraft, stored in computer-readable form in the ground-based computer.

4. System according to claim 3, and further comprising:
f) means for causing changes made in the second maintenance manual to be replicated in the first maintenance manual.

5. A system, comprising:
a) an aircraft;
b) computer-readable memory, carried by the aircraft, which stores content containing at least one document in the following group;
i) maintenance manual for the aircraft;
ii) maintenance log of the aircraft;
iii) configuration log of the aircraft; and
c) means for enabling a crew member of the aircraft to read the content.

6. System according to claim 5, wherein the group further contains
iv) pilot logbooks.

7. System according to claim 6, wherein the group further contains
v) taskcards.

8. System according to claim 7, and further comprising:
d) means for receiving data from a remote source, and modifying the content, using the data.

9. System according to claim 7, and further comprising:
d) means for updating the content, in response to messages received from an external source.

10. A method, comprising:
a) onboard an aircraft, maintaining a maintenance manual for the aircraft in computer-readable form; and
b) at intervals, modifying the manual.

11. Method according to claim 10, and further comprising:
c) onboard the aircraft, maintaining a maintenance log of the aircraft in computer-readable form.

12. Method according to claim 11, and further comprising:
d) onboard the aircraft, maintaining a configuration log of the aircraft, in computer-readable form.

13. A method, comprising the following steps:
a) maintaining, onboard an aircraft, a first set of documents in computer-readable form, said first set of documents comprising one or more of the following:
i) a maintenance manual for the aircraft;
ii) a maintenance log of the aircraft;
iii) a configuration log of the aircraft; and
iv) pilot logbooks;
b) causing alterations to occur in the first set;
c) maintaining, at an earth-based site, a second set of documents in computer-readable form, said second set of documents comprising one or more of the following:
i) a maintenance manual for the aircraft;
ii) a maintenance log of the aircraft;
iii) a configuration log of the aircraft; and
iv) pilot logbooks; and
d) replicating the alterations into the second set of documents.
